(19) United States
(12) Patent Application Publication
(10) Pub. No.: US 2008/0078661 A1
(43) Pub. Date: Apr. 3, 2008

(54) Portable Information Device

(75) Inventors: Tadanao Matsumoto, Tokyo (JP); Tsuyoshi Takiguchi, Tokyo (JP); Naoki Iwao, Tokyo (JP)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Japan Aviation Electronics Industry Limited, Tokyo (JP)

(21) Appl. No.: 11/904,922

(22) Filed: Sep. 28, 2007

(30) Foreign Application Priority Data
Oct. 2, 2006 (JP) 2006-271056

(51) Int. Cl. H01H 9/00; H01H 3/02

(52) U.S. Cl. 200/17 R; 200/52 R

(57) ABSTRACT

A first predetermined operation is performed when a contact detector detects contact with an operation knob. A time length of the contact thus detected by the contact detector is measured and it is determined whether the time length of the contact is longer or shorter than a predetermined value. When it is determined that the time length of the contact is longer or shorter than the predetermined value, a second predetermined operation is performed.

### TECHNICAL FIELD

The present invention relates to a portable information device including a cellular phone, a PHS phone, a PDA, and a digital camera, and particularly relates to the operation means of a portable information device.

### DESCRIPTION OF THE RELATED ART

Cellular phones and digital cameras include switches called 5-way switches for performing various operations. FIG. 18 represents the outline of a cellular phone including a 5-way switch. A 5-way switch 11 has points denoted as 1 to 5 in an operation knob 12 shaped like a ring. By pressing these points, various operations can be performed. Generally, items are selected by pressing the points denoted as 1 to 4 in the operation knob 12 shaped like a ring, and the selected items can be confirmed by pressing a central operation knob 13 shaped like a circle denoted as 5. In FIG. 18, reference numeral 21 denotes a phone body and reference numeral 22 denotes a display.

FIG. 19 illustrates the screen of the display 22. For example, when an item is to be selected on the screen of FIG. 19A, a selection area is moved upward by pressing the point denoted as 1 in the operation knob 12 and thus “002 BBB” can be selected as shown in FIG. 19B. By pressing the central operation knob 13 (on the point denoted as 5) while “002 BBB” is selected, “002 BBB” can be executed. When the items shown in FIG. 19 are music, the music of “002 BBB” is reproduced by pressing the central operation knob 13.

Incidentally, the operations of recent cellular phones are hard to perform only with such a 5-way switch because there is a growing need in the market for browsing the Internet with cellular phones as current browsing with personal computers (hereinafter, will be referred to as PCs) and so on.

Conventionally, cellular phones have displayed different Internet screens from those of PCs and thus the operations have been sufficiently performed with 5-way switches. However, with higher functionality, cellular phones having the function of displaying Internet screens as PCs (generally, called full browser) have become available in recent years.

With the emergence of such cellular phones, various operations have been desired for cellular phones. To be specific, a pointing device capable of operating, e.g., a cursor has been desired.

For example, Japanese Patent Application Laid-Open No. 2006-197159 describes a cellular phone including a pointing device capable of operating a cursor. The cellular phone has the pointing device disposed on the part of a pressing switch at the center of a conventional 5-way switch.

The pointing device can operate the cursor by moving (sliding) a central operation knob 13′ in multiple directions as indicated by arrows in FIG. 20. The pointing device also has the function of a switch operated by a press. For example, various operations can be enabled by the pointing device.

The above pointing device slides a central operation knob and operates a cursor according to a change of the amount of movement of the central operation knob, and thus the pointing device requires an area for sliding the central operation knob. Therefore, the size reduction of the pointing device is limited and thus the pointing device interferes with the size reduction of a portable information device including cellular phones with the pointing device.

### SUMMARY OF THE INVENTION

In view of this problem, it is an object of the present invention to provide a portable information device including an operation device capable of finely performing various operations such as a cursor operation with a small configuration.

The present invention includes contact detector for performing a first predetermined operation when contact is detected. The time length of contact detected by the contact detector is measured and it is determined whether the time length of contact is longer or shorter than a predetermined value. When it is determined that the time length of contact is longer or shorter than the predetermined value, a second predetermined operation is performed.

### BRIEF DESCRIPTION OF THE DRAWINGS

FIG. 1 is a plan view representing the external outline of a first example of a portable information device according to the present invention;

FIG. 2A is a perspective view representing a partially exploded operation device of FIG. 1;

FIG. 2B is a plan view of the operation device;

FIG. 2C is a sectional view taken along line A-A of the operation device shown in FIG. 2B;

FIG. 3 is a block diagram representing the main part of the circuit configuration of a cellular phone shown in FIG. 1;

FIG. 4 is a flowchart representing a flow of cursor and screen control according to the first example;

FIG. 5A represents a state before a cursor moves;

FIG. 5B represents a state in which the cursor is moving;

FIG. 6A represents a state before the cursor speeds up;

FIG. 6B represents a state in which the cursor is speeding up;

FIG. 7A represents a state before scrolling;

FIG. 7B represents a state after the scrolling;

FIG. 8 represents an example of a confirming operation;

FIG. 9 is a flowchart representing cursor and screen control according to a second example of the present invention;

FIG. 10A represents a state before scrolling;

FIG. 10B represents a state after the scrolling;

FIG. 11A represents a state before an icon becomes active;

FIG. 11B represents a change of the active icon;

FIG. 11C represents a state in which a pop-up menu is displayed.

FIG. 12 is a flowchart representing cursor and screen control according to a fifth example of the present invention;

FIG. 13A represents a state before a screen is zoomed in;

FIG. 13B represents a state after the screen is zoomed in;

FIG. 14 is a plan view representing the external outline of a portable information device according to a sixth example of the present invention;

FIG. 15 is a block diagram representing the main part of the circuit configuration of a cellular phone shown in FIG. 14;

FIG. 16 is a flowchart representing a flow of a change of functions according to the sixth example;

FIG. 17A represents a state before the allocation of functions is changed;

FIG. 17B represents a state after the allocation of functions is changed;

FIG. 18 is a plan view representing the external outline of a conventional example of a cellular phone;

FIG. 19A represents a state before a cursor moves;

FIG. 19B represents a state after the cursor moves; and

FIG. 20 is a plan view representing the external outline of another conventional example of a cellular phone.

### BEST MODE FOR CARRYING OUT THE INVENTION

The following will describe embodiments of the present invention based on examples with reference to the accompanying drawings.

### FIRST EXAMPLE

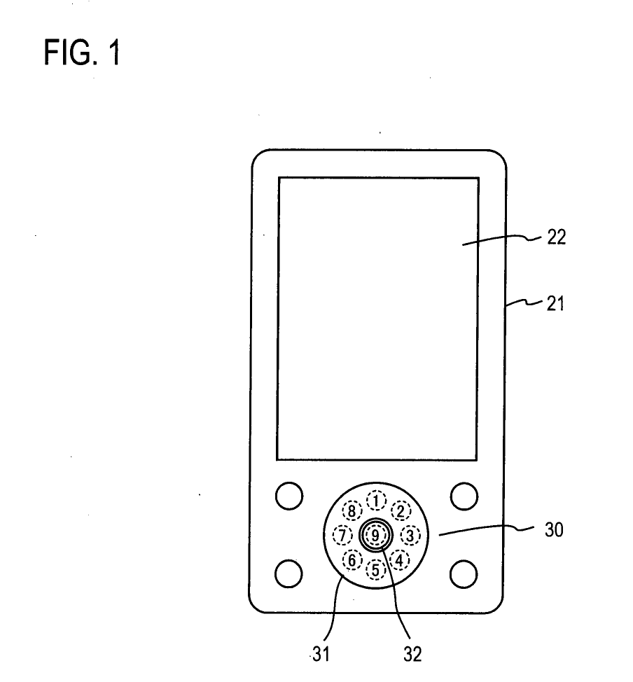

FIG. 1 represents the external outline of a cellular phone as an example of a portable information device of the present invention. In FIG. 1, reference numeral 21 denotes a phone body and reference numeral 22 denotes a display.

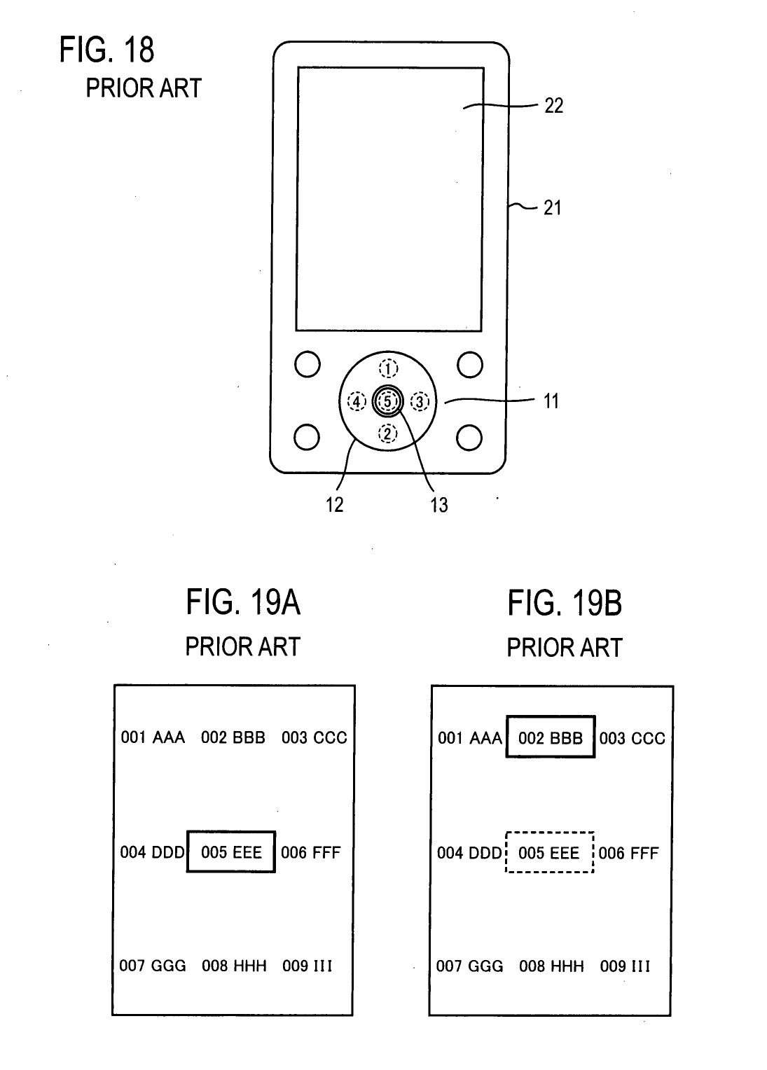

In this example, the phone body 21 includes a 5-way switch operated by a press as the conventional cellular phone shown in FIG. 18. The 5-way switch further includes a contact detector (touch sensor). The contact detector detects finger contact with an operation knob 31 shaped like a ring. In this example, eight contact detectors are disposed at regular angular intervals around the center of the operation knob 31, that is, at 45 degree intervals. Reference numerals 1 to 8 of the operation knob 31 denote points where the contact detectors are disposed.

As switches operated by a press, switches (click switches) 33 making clicks are disposed on the points denoted as 1, 3, 5 and 7 in the operation knob 31. In the operation knob 31, the switches 33 disposed in four directions relative to the center can be selected by a press, and a finger contact position in the operation knob 31 can be detected by the eight contact detectors. The contact detector is not disposed on a central operation knob 32 denoted as 9 and only a switch operated by a press is disposed on the central operation knob.

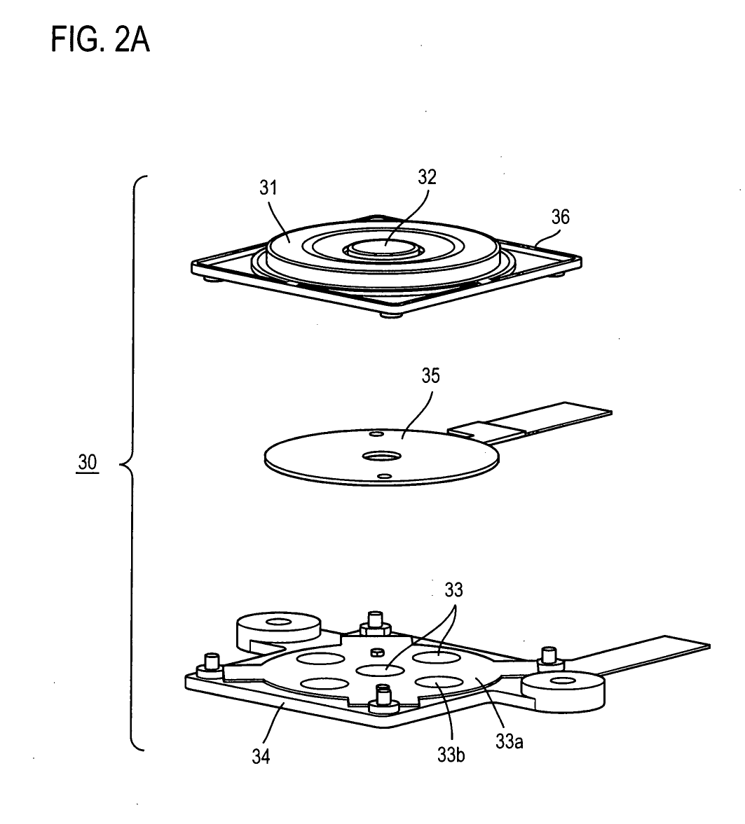

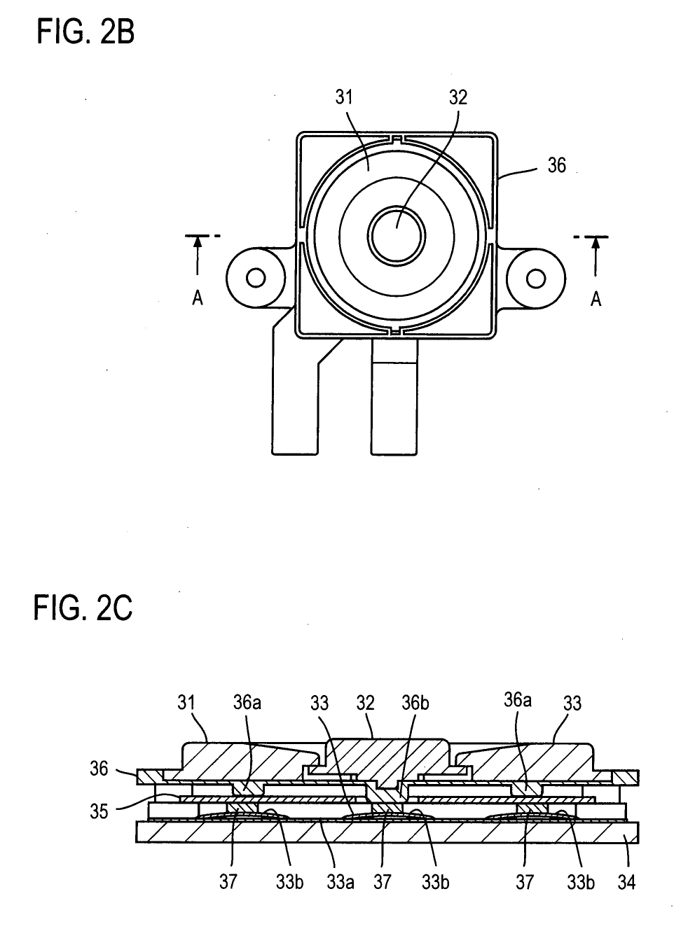

FIG. 2A is a partially exploded view representing the configuration of an operation device 30 including the contact detectors added to the 5-way switch. FIG. 2B is a front view of the operation device 30. FIG. 2C is a sectional view taken along line A-A of the operation device 30. The five switches 33 operated by a press are made up of an FPC 33a which is disposed on a base 34 and has contact patterns formed thereon and click domes 33b which are disposed on the respective contact patterns. In this example, a membrane switch is disposed as contact detector 35 between the switches 33 and the operation knob 31. The contact detector 35 is not limited to a membrane switch (pressure sensitive switch) and thus can be a capacitance switch.

On the undersides of the operation knob 31 and the central operation knob 32, a rubber sheet 36 is provided. The rubber sheet 36 has pressing protrusions 36a and 36b formed thereon. The pressing protrusions 36a and 36b correspond to the points denoted as 1 to 9 in the operation knob 31 and the central operation knob 32.

Between the contact detector 35 and the click domes 33b and between the pressing protrusion 36b corresponding to the central operation knob 32 and the click dome 33b, blocks 37 are provided. When the operation knob 31 and the central operation knob 32 are pressed down, the click domes 33b are pressed through the blocks 37.

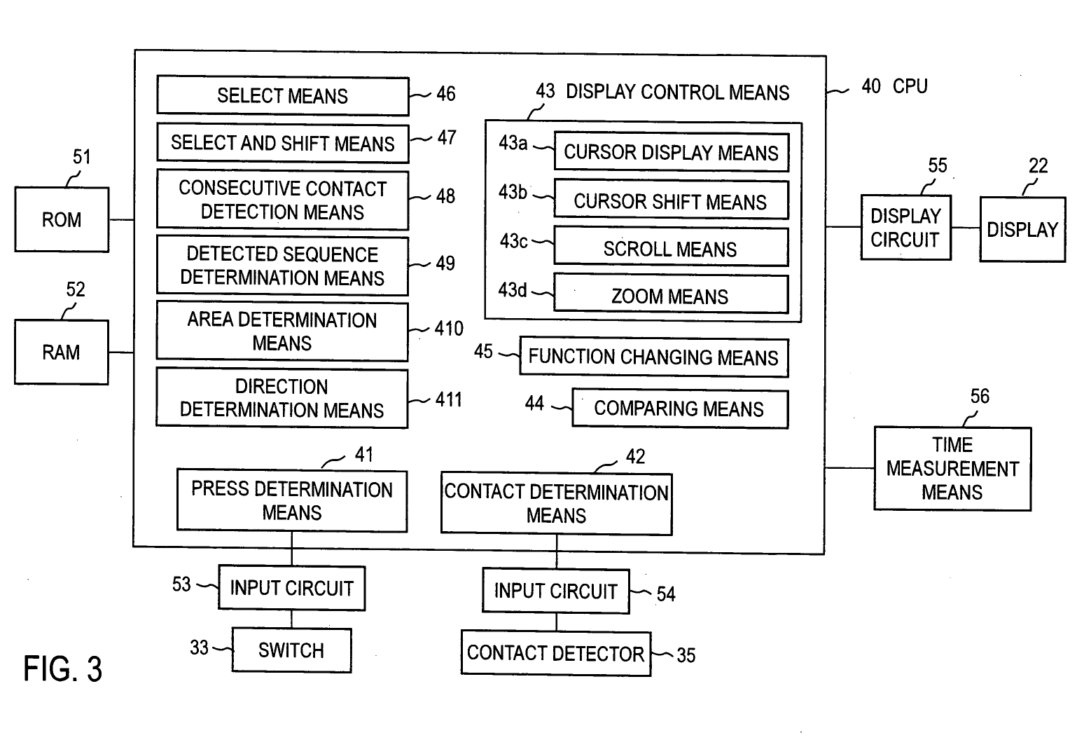

FIG. 3 represents the main part of the circuit configuration of the cellular phone. The cellular phone includes a CPU 40, a ROM 51, a RAM 52, input circuits 53 and 54, a display circuit 55, and time measurement means 56. The switch 33 and the contact detectors 35 are connected to the input circuits 53 and 54, respectively. The display 22 is connected to the display circuit 55. In FIG. 3, circuits for communications and music and the like are not shown.

The ROM 51 stores a control program for controlling the parts of the cellular phone and stores fixed data. The RAM 52 stores temporary data.

Press determination means 41, contact determination means 42, display control means 43, comparing means 44, function changing means 45, select means 46, select and shift means 47, consecutive contact detector 48, detected sequence determination means 49, area determination means 410, and direction determination means 411 are caused to act by the CPU 40. The display control means 43 includes cursor display means 43a, cursor shift means 43b, scroll means 43c, and zoom means 43d.

The cursor shift means 43b corresponds to first operation means in claims, and the function changing means 45 corresponds to second operation means in claims. The zoom means 43d and detected sequence determination means 49 also correspond to second operation means in claims.

The press determination means 41 determines whether the switches 33 are pressed or not. To be specific, the press determination means 41 determines which of the five switches 33 has been pressed by the operation knob 31 or the central operation knob 32. The contact determination means 42 determines which of the eight contact detectors 35 has detected contact with the operation knob 31. The contact determination means 42 detects a selected contact detector 35 that is selected by contact therewith. The contact detector 35 detects any contact with the operation knob 31. In the present specification, an example in which the operation knob 31 is operated by a finger will be described. The cursor display means 43a displays a cursor on a display field of the display 22. The cursor shift means 43b shifts the cursor on the display 22. The scroll means 43c scrolls a screen image displayed in the display field. The zoom means 43d zooms in and out on a display screen of the display 22.

The comparing means 44 compares a time length of contact measured by the time measurement means 56 and a predetermined value. When the comparing means 44 determines that the time length of contact measured by the time measurement means 56 exceeds the predetermined value, the function changing means 45 outputs a signal for changing an operation performed on the display 22.

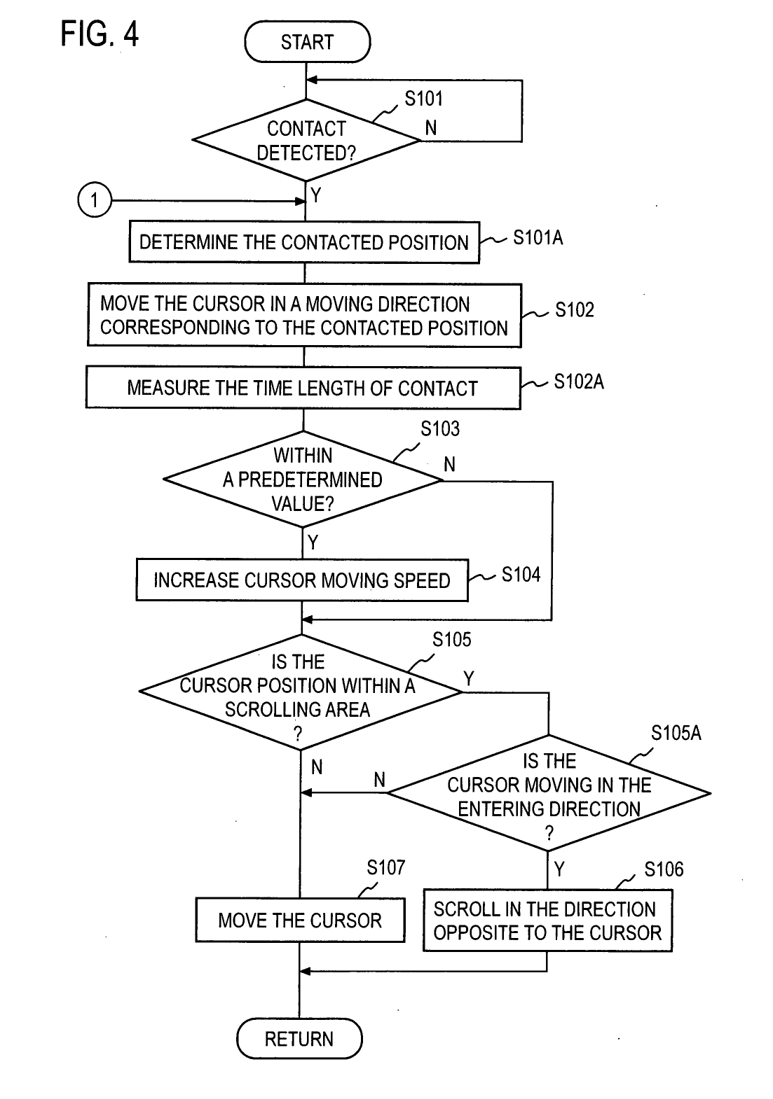

FIG. 4 represents a flow of cursor and screen control based on finger contact detection performed by the contact detector 35 in the cellular phone configured thus. The steps will be sequentially described below.

The contact detector 35 determines whether contact with the operation knob 31 has been detected or not (step S101).

When the contact detector 35 detects contact with the operation knob 31, the contact determination means 42 detects a selected contact detector 35 that is selected by contact therewith (step S101A).

Each of the contact detectors 35 is assigned to predetermined direction, respectively. For-example, the directions along which the contact detectors 35 are positioned relative to the center of the operation knob 31 are determined beforehand. The cursor shift means 43b moves the cursor at a predetermined speed in a predetermined direction corresponding to the selected contact detector 35 detected by the contact determination means 42 (step S102).

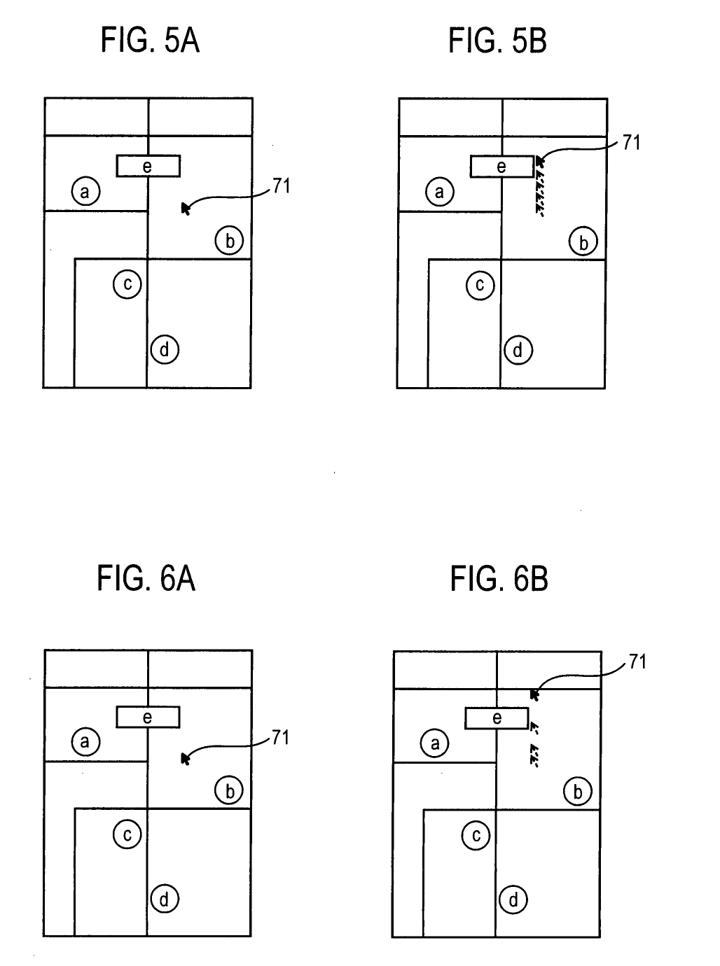

FIG. 5 represents a movement of a cursor 71 when a map is displayed on the display field of the display 22. FIG. 5A represents a state before the cursor 71 moves. FIG. 5B represents a state in which the cursor 71 is moving. For example, in FIG. 5A, circled “a” denotes a pub, circled “b” denotes a movie theater, circled “c” denotes a convenience store, circled “d” denotes a karaoke bar, and “e” in a rectangle denotes a station.

When a finger is in contact with the point denoted as 1 in the operation knob 31, the cursor 71 moves upward as shown in FIG. 5B.

When the contact detector 35 detects the contact with the operation knob 31, the time measurement means 56 measures the time length of the contact state of the finger (step S102A).

The comparing means 44 determines whether or not the measured time length exceeds a predetermined time length(step S103).

When the comparing means 44 determines that the measured time length exceeds the predetermined time length, the cursor shift means 43b increases the moving speed of the cursor 71 in response to the signal outputted from the function changing means 45 (step S104). The moving speed of the cursor 71 may be increased only by a predetermined value or the cursor 71 may speed up with the duration of the contact state.

FIG. 6 represents, as FIG. 5, that the cursor 71 speeds up on the map screen when a finger is in contact with the point denoted as 1 in the operation knob 31. FIG. 6A represents a state before the cursor 71 speeds up. FIG. 6B represents a state in which the cursor 71 is speeding up.

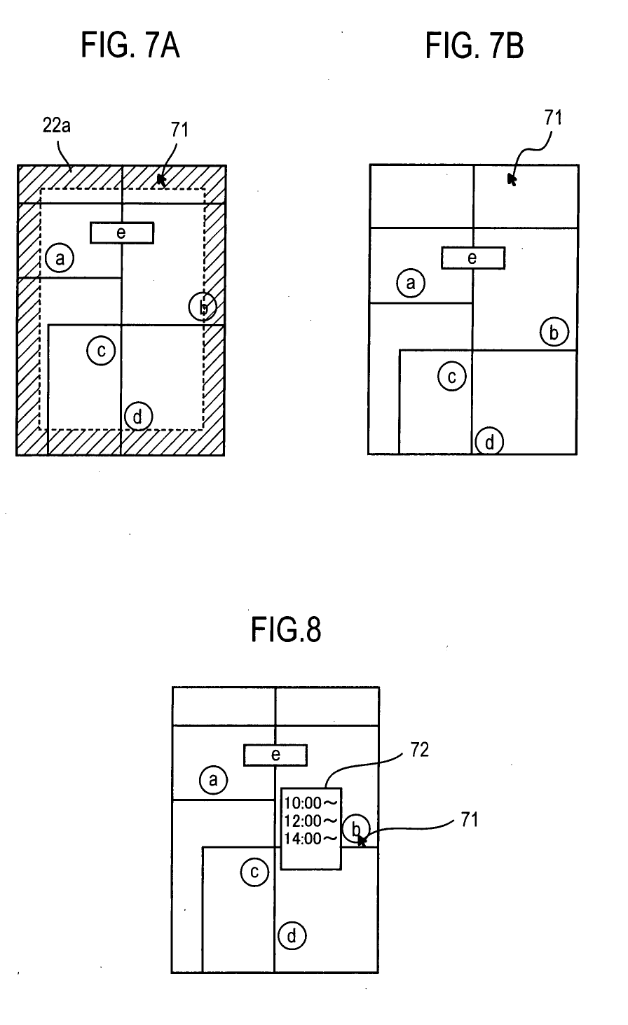

Further, in this example, a scrolling area 22a is set on the edge of portion around the display field of the display 22 as shown in FIG. 7A. By moving the cursor 71 into the scrolling area 22a, the screen can be scrolled.

In other words, the area determination means 410 determines whether or not the cursor is in the scrolling area 22a, that is, whether or not the cursor 71 has entered the scrolling area 22a (step S105).

When the cursor has entered the scrolling area 22a, the direction determination means 411 determines whether or not cursor means has outputted a signal for further moving the cursor 71 in the entering direction, that is, whether or not the cursor shift means 43b moved the cursor 71 in the entering direction and continues its operation(step S105A).

When the cursor 71 has been further moved in the entering direction, the scroll means 43c scrolls the screen image in the opposite direction (cursor movement direction) that is opposite to the entering direction of the cursor 71 (step S106).

FIG. 7A represents a state before the scrolling, and FIG. 7B represents a state after the scrolling. When the cursor 71 has not entered the scrolling area 22a or when the cursor 71 has entered the scrolling area 22a but the signal for moving the cursor 71 in the entering direction of the cursor 71 has not been outputted, the cursor 71 is kept moving without scrolling the screen (step S107).

FIG. 8 represents an example of a state in which the central operation knob 32 (the point denoted as 9) is pressed and the switch (click switch) is turned on while the cursor 71 is put on an icon on the map. In this example, a pop-up menu 72 is displayed to confirm the show times of the movie theater (circled “b”).

Instead of the pop-up menu 72 displayed in this example, a link may be provided in the icon. The screen may be shifted to a linked site by pressing the central operation knob 32 and turning on the switch while the cursor 71 is placed on the icon.

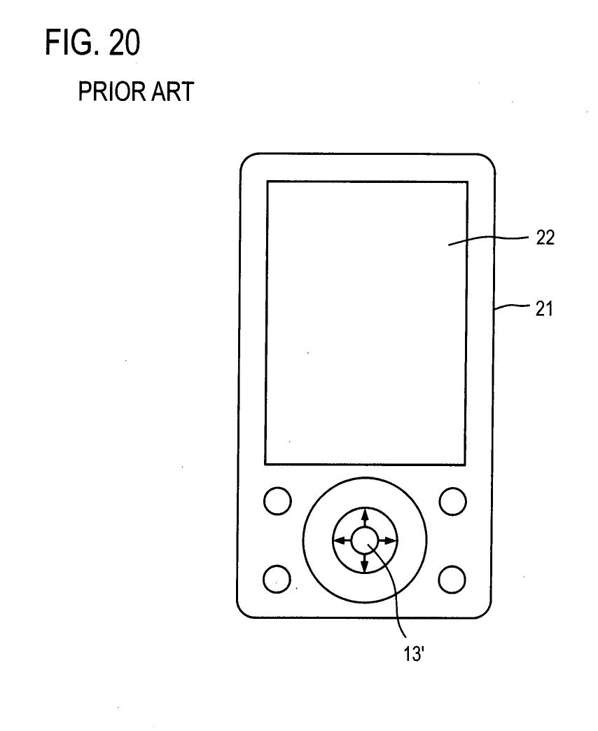

As described above, in this example, finger contact with the operation knob 31 enables cursor operations in multiple directions and further enables scrolling. It is therefore possible to eliminate the need for a sliding area unlike the pointing device of FIG. 20. Since a sliding area is not necessary, it is possible to reduce the size of the portable information device requiring cursor operations. For example, the pointing function of the cursor may be added to the portable information device as large as the conventional 5-way switch of FIG. 18.

In the conventional example of FIG. 20, the central operation knob 13′ is provided with two functions of selection and confirmation, whereas in this example, select means and confirmation means are clearly separated such that the cursor is moved and an icon is selected in response to contact with the ring-shaped operation knob 31 and the selected icon is confirmed by pressing the central operation knob 32. Thus the selected icon is not displaced during confirmation. In this respect, misoperations can be reduced.

In this example, the cursor and the screen can be both moved in response to contact with the operation knob 31 and thus desired functions can be allocated to the switches 33 operated in four directions by pressing the operation knob 31. In this respect, it is possible to achieve a portable information device with high operability.

Additionally, the time length of contact with the operation knob 31 and the predetermined time length are compared with each other. When the time of contact exceeds the time length, operations to be performed are changed (switched). In this respect, various operations can be finely performed.

In this example, finger contact with the operation knob 31 is detected on the eight points denoted as 1 to 8 and the cursor can be moved in eight directions. Instead of the eight points, contact may be detected on, for example, the four points of 1, 3, 5 and 7 and may be detected on sixteen points.

In this example, the ring-shaped operation knob 31 includes the contact detectors (touch sensor) 35 and the central operation knob 32 does not include the contact detector. The location of the contact detector is not particularly limited. The central operation knob 32 may include a plurality of contact detectors and the ring-shaped operation knob 31 may not include the contact detector.

### SECOND EXAMPLE

In the first example, the cursor can be moved and the screen image is scrolled by finger contact with the operation knob 31, whereas in this example, a cursor is moved by finger contact with an operation knob 31 and the screen image is scrolled by pressing a switch 33 in response to a press of the operation knob 31.

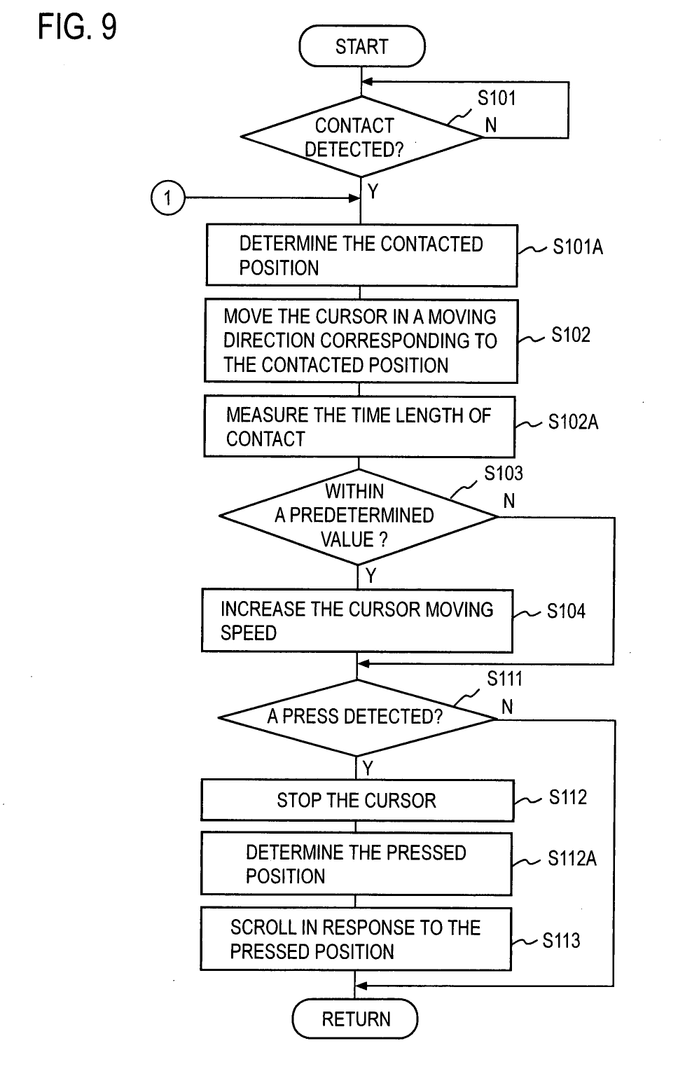

FIG. 9 represents a flow of cursor control and screen control. Steps S101 to S104 in FIG. 9 are similar to those of the first example.

The switch 33 detects whether the operation knob 31 has been pressed or not (step S111).

When the switch 33 detects a press of the operation knob 31, the switch 33 stops the operation of the cursor (step S112).

The press determination means 41 detects a selected switch of the switches 33 that is selected by pressing(step S112A).

Scrolling means scrolls a screen image according to a pressed position, that is, the position of the switch 33 having been turned on (step S113).

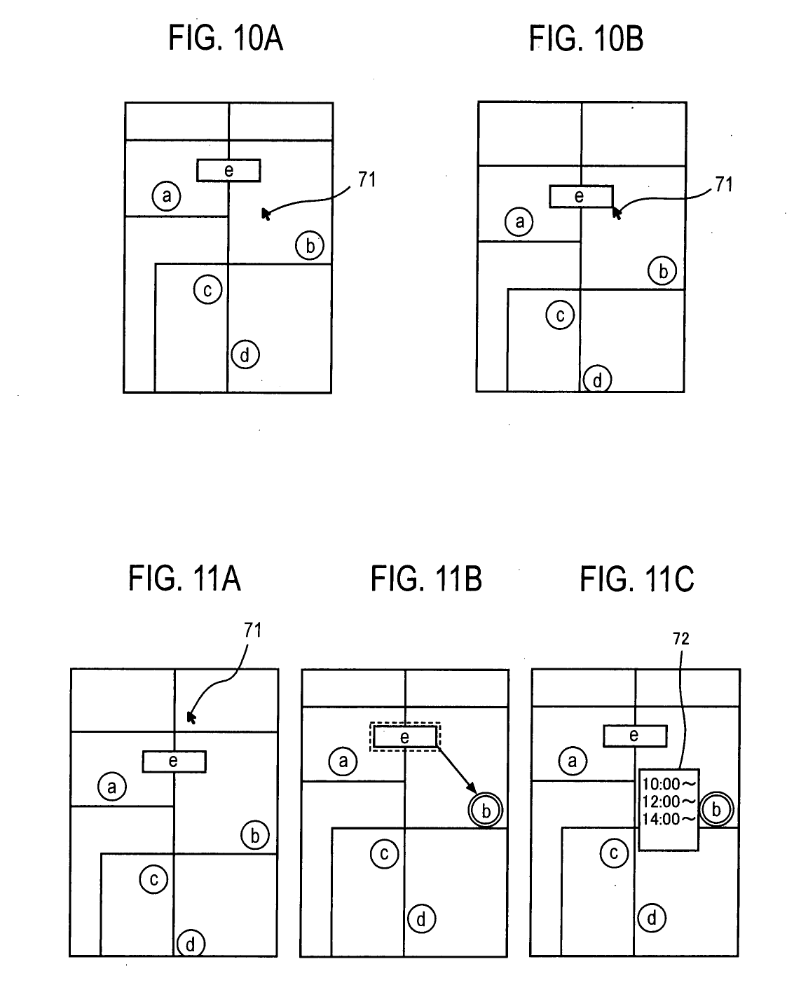

FIG. 10 represents a state of the scrolling. FIG. 10A represents a state before the scrolling and FIG. 10B represents a state after the scrolling. When a point denoted as 1 in the operation knob 31 is pressed and the switch 33 is turned on, the screen is scrolled down as shown in FIG. 10A. At this moment, contact detector 35 detects contact with the point denoted as 1 and the cursor is supposed to move upward. However, the operation of the cursor is stopped when the screen image is scrolled in a manner so as not to miss the position of the cursor during the transition from scrolling to a cursor movement by a user in, for example, the processing of step S112.

As described in the second example, a scrolling function may be allocated to the switches 33 in four directions.

### THIRD EXAMPLE

In a third example, the function of speeding up a cursor is allocated to switches 33. A cursor operation and a scrolling operation in response to contact with an operation knob 31 are similar to those of the first example.

Each of the switches 33 is assigned to a predetermined direction, respectively. For example, the directions along which the switches 33 are positioned relative to the center of the operation knob 31 are determined beforehand. In this example, the switches 33 are allocated such that a point denoted as 1 is “up”, a point denoted as 3 is “right”, a point denoted as 5 is “down”, and a point denoted as 7 is “left”.

In this example, when the point denoted as 1 in the operation knob 31 is pressed and the switch 33 is turned on, the cursor speeds up in an upward direction. This speedup is similar to that of the cursor shown in FIG. 6 of the first example. The cursor speeds up in the direction along which the pressed switch 33 is positioned relative to the center of the operation knob 31. To be specific, the switch 33 detects a press of the operation knob 31. Press determination means detects a selected switch that is selected by pressing. Cursor shift means 43b increases the speed of the cursor in the predetermined direction corresponding to the selected switch.

In this example, in addition to a cursor movement made by the contact detectors 35, the function of speeding up the cursor is added to the switches 33, so that icons are selected and the screen is largely scrolled in a comfortable manner.

As a matter of course, when an icon is selected, a slow cursor can be more easily put on the icon on a predetermined position. However, large scrolling takes a long time when a cursor is slow. In this example, it is only necessary to press the operation knob 31 to speed up the cursor when largely scrolling the screen, thereby achieving high operability.

The speedup of the cursor according to the third example can be compatible with the method of speeding up the cursor according to the first example. Therefore, when the operation knob 31 is contacted for a predetermined value or longer, the cursor can speed up according to the means and method of the first example, and when the operation knob 31 is pressed down, the cursor can further speed up according to the means and method of the third example. Thus the operability of the cursor further improves.

### FOURTH EXAMPLE

In a fourth example, an undefined function of the switch 33 in the first example is allocated to an active state movement of an icon. A cursor operation and a scrolling operation are similar to those of the first example.

FIG. 11 represents this state. In the state of FIG. 11A, one of points denoted as 1, 3, 5 and 7 in an operation knob 31 is pressed and a switch 33 is turned on, so that an icon near a cursor becomes active. In other words, when the switch 33 detects a press of the operation knob 31, select means 46 activates the icon near the cursor. In FIG. 11A, a station icon circled “c” is the closest to the cursor, so that the station icon becomes active. “Active” means a state in which the icon is selected.

After that, the point denoted as 3 in the operation knob 31 is pressed and the switch 33 is turned on, so that a movie icon circled “b” on the right of the station icon circled “c” becomes active as shown in FIG. 11B. In other words, when the switch 33 detects a press of the operation knob 31, press determination means 41 detects the selected switch that is pressed down. Select and shift means 47 activates an icon in a predetermined direction corresponding to the pressed switch 33 relative to the currently active icon.

Further, when the movie icon circled “b” is active, a central operation knob 32 is pressed and the switch 33 is turned on. In this case, a pop-up menu is displayed as shown in FIG. 11C, so that the showing times of movies can be confirmed.

In this example, as described above, the operation knob 31 is pressed and the switches 33 disposed in four directions are turned on as appropriate, so that an active state can be moved. In other words, in addition to the selection of an icon by means of the cursor, an active state is moved by the switches 33, so that a desired icon can be selected faster than selection by a cursor movement.

Moreover, selection by a cursor and selection by a click can be both provided by a single operation device (pointing device), so that a user can select an operation method by him/herself. In this respect, the present invention can be accepted by more users.

### FIFTH EXAMPLE

In a fifth example, as in the first example, a cursor is moved and a screen is scrolled in response to finger contact with an operation knob 31, that is, in response to detection of contact in contact detector 35. However, in the fifth example, when consecutive contact is consecutively detected by the contact detectors 35 disposed on points denoted as 1 to 8 in the operation knob 31, in other words, when operations are consecutively performed (hereinafter, will be referred to as a motion input) on a plurality of the contact detectors 35, a display screen is zoomed in and out.

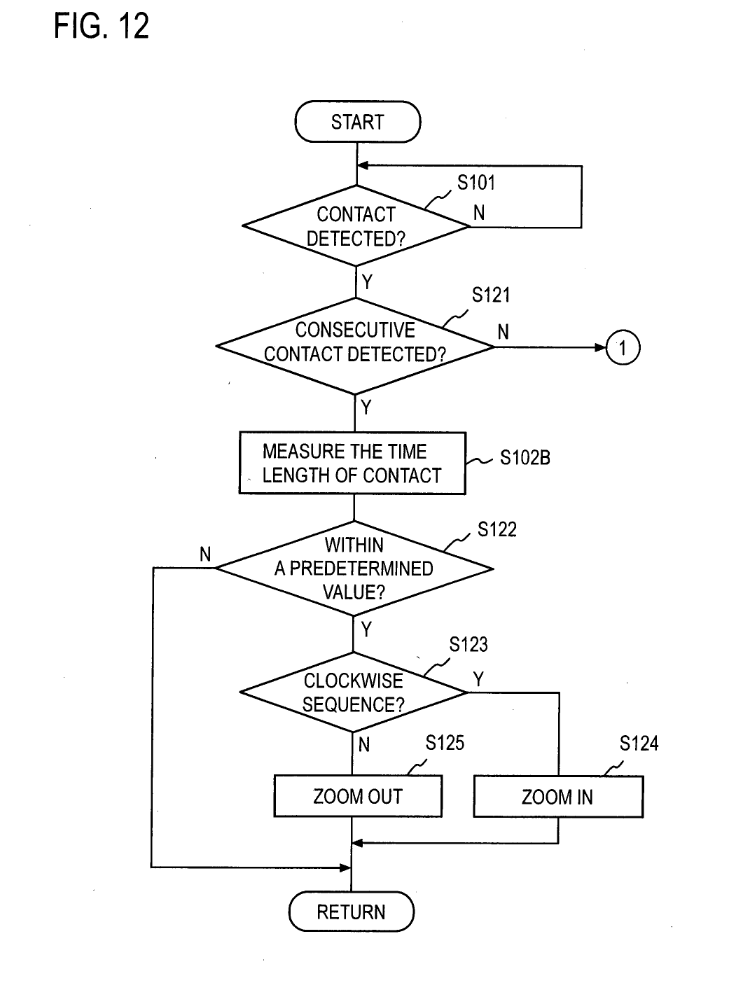

FIG. 12 represents a flow of screen control of this case. First, the contact detector 35 determines whether contact with the operation knob 31 has been detected or not (step S101).

Consecutive contact detector 48 determines, when contact is detected, whether the contact has been consecutively detected on the plurality of points (step S121). In other words, the consecutive contact detector 48 detects whether or not a consecutive contact with the operation knob is detected by a predetermined number of sequentially arranged contact detectors 35 and also detects a detection sequence. To be specific, the consecutive contact detector 48 detects whether or not contact has been consecutively detected on, for example, five points out of the points denoted as 1 to 8 in the operation knob 31.

When the consecutive contact detector 48 detects the consecutive contact, time measurement means 56 measures the time length of the consecutive contact with the operation knob 31 (step S102B).

Comparing means 44 determines whether or not an input time, that is, the time length of the consecutive contact is within a predetermined value (step S122).

Detected sequence determination means 49 determines, when the input time is within the predetermined value, whether or not the input sequence (detection sequence) is in a clockwise direction (step S123).

When the input sequence is in the clockwise direction, the screen is zoomed in (step S124).

When the input sequence is in a counterclockwise direction, the screen is zoomed out (step S125).

When the consecutive contact detector 48 does not detects the consecutive contact in step S121, the process advances to step S101A of the flowchart of FIG. 4 (or the flowchart of FIG. 9).

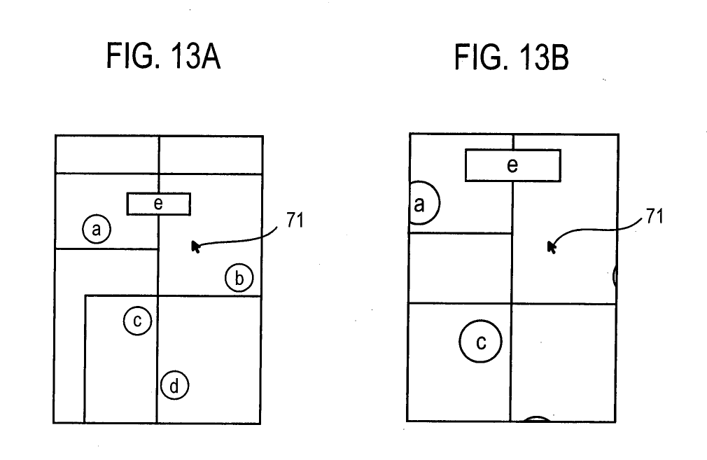

FIG. 13 represents as an example a state in which the screen is zoomed in. FIG. 13A represents a state before the screen is zoomed in and FIG. 13B represents a state after the screen is zoomed in. In this example, the points denoted as 1 to 5 in the operation knob 31 are consecutively contacted in this order, so that a map displayed on a display 22 is zoomed in.

In this example, the number of times of consecutive contact detection is five (five points). The number of times of consecutive contact detection is not particularly limited as long as contact is detected multiple times. However, since contact is detected on the five points in this example, that is, halfway around the ring-shaped operation knob 31, a motion input can be more positively detected.

The screen may be zoomed out when the input sequence is in the clockwise direction (step S124′) and the screen may be zoomed in when the input sequence is in the counterclockwise direction (step S125′). Further, a given function of turning up or down a volume may be allocated to the input sequence in the clockwise direction or the counterclockwise direction.

### SIXTH EXAMPLE

In this example, the portable information device includes a plurality of switches operated by pressing operation knobs, wherein contact detectors for detecting finger contact on the operation knobs are disposed on the respective operation knobs, and when the contact detectors disposed on the operation knobs consecutively detect finger contact in a predetermined time length, that is, when a motion input is made, functions allocated to the switches are changed.

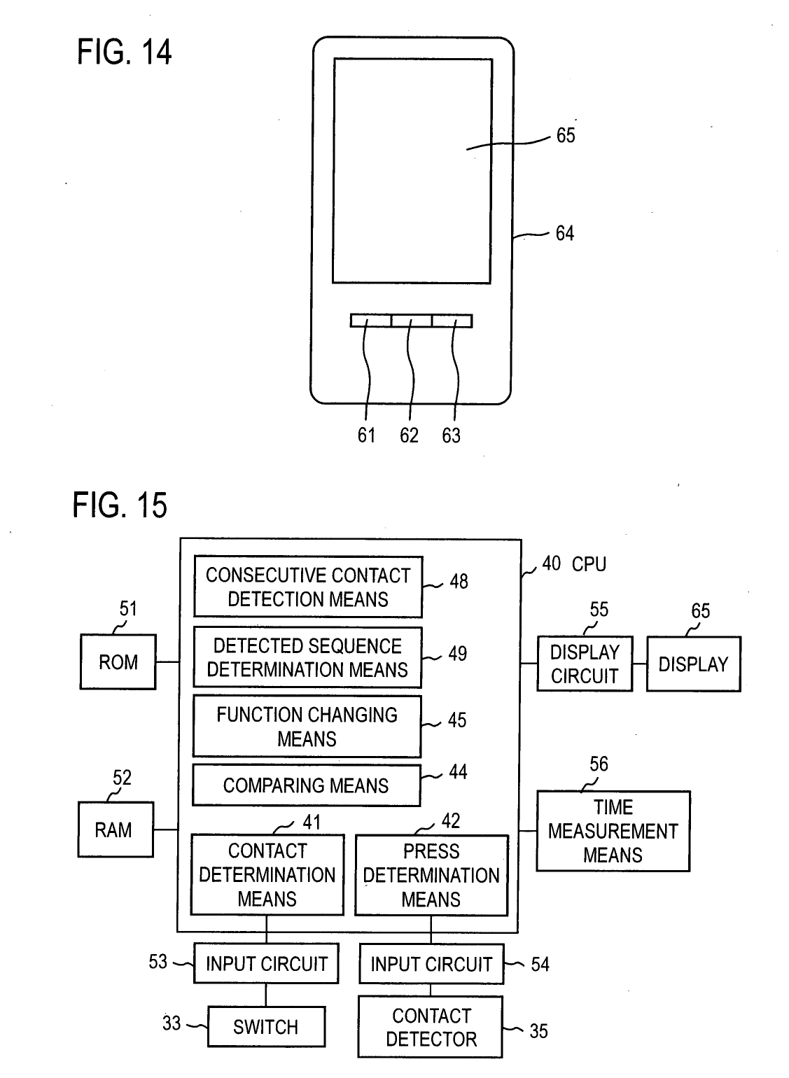

As shown in FIG. 14, a cellular phone has three rectangular operation knobs 61 to 63. The contact detectors are respectively disposed on the operation knobs 61 to 63, and switches (click switches) are respectively disposed under the contact detectors in the same configuration as FIG. 2. In other words, the switches, the operation knobs, and the contact detectors are equal in number. In FIG. 14, reference numeral 64 denotes a phone body and reference numeral 65 denotes a display.

FIG. 15 represents the main part of the circuit configuration of the cellular phone. Parts corresponding to those of FIG. 3 are indicated by the same reference numerals and the detailed explanation thereof is omitted.

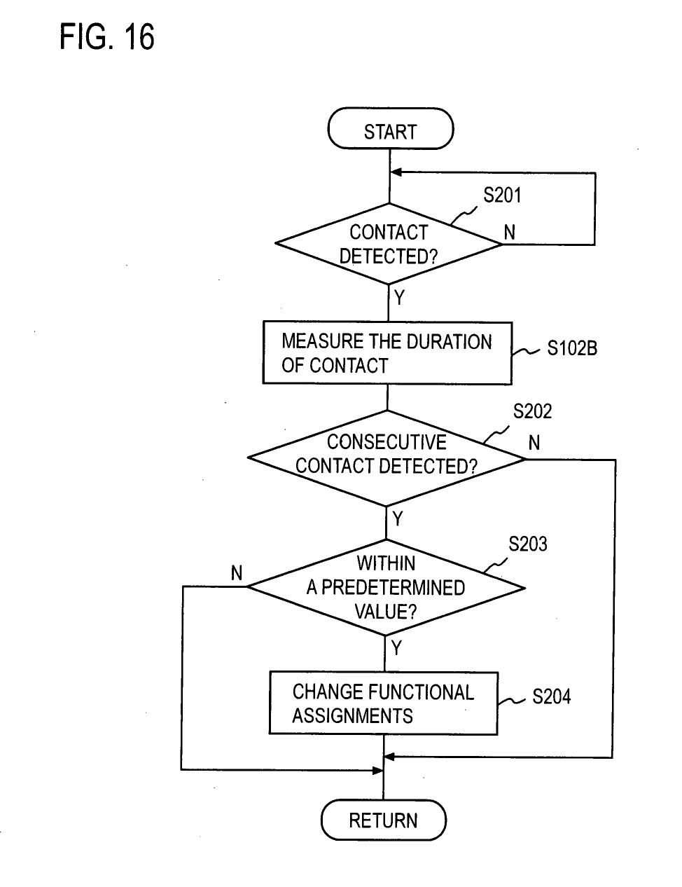

FIG. 16 represents a flow of a change of functions in response to a motion input in the cellular phone configured thus.

Contact detection means 35 determines whether a finger is in contact with the operation knobs 61 to 63 (step S201).

Consecutive contact detector 48 detects, when contact is detected, whether a consecutive contact with the three operation knobs 61 to 63 is detected by the three contact detection means 35 (step S202).

When the consecutive contact is detected, time measurement means 56 measures a time length of the detected consecutive contact with the operation konbs. And comparing means 44 determines whether the time length of the detected consecutive contact is within a predetermined value or not (step S203).

When the time length is within the predetermined value, function changing means 45 changes functions allocated to the switches (step S204).

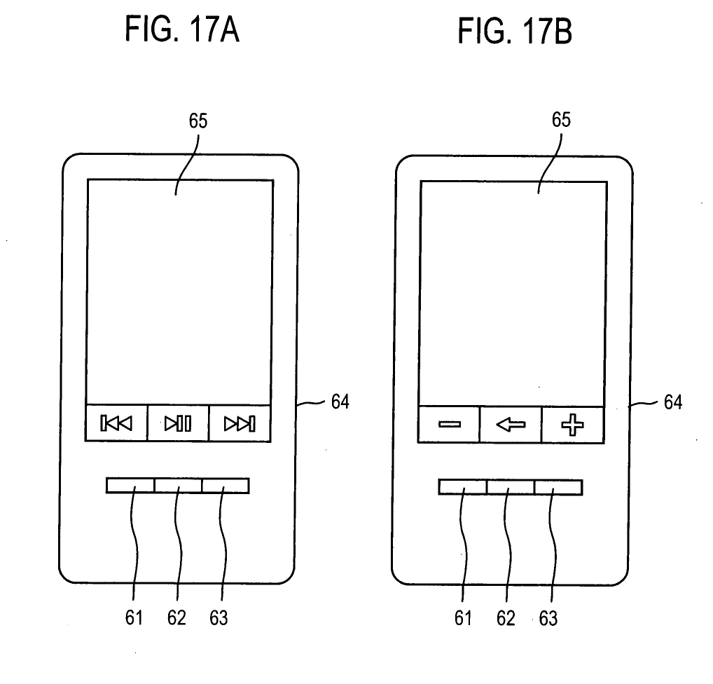

FIG. 17 represents an example in which the allocation of functions is changed. As shown in FIG. 17A, three functions (skip backward, play, skip forward) for operating a music player are allocated beforehand to the switches of the operation knobs 61 to 63. In response to a motion input to the operation knobs 61 to 63, the functions allocated to the switches of the operation knobs 61 to 63 are changed to three functions of volume up, ←(return to the menu), and volume up as shown in FIG. 17B.

As shown in FIG. 17, the current functions of the operation knobs 61 to 63 are displayed on the lower part of the display 65, so that the current functions allocated to the switches are positively recognized.

In this example, when the contact detectors are consecutively operated in the predetermined time length, the functions allocated to the switches can be changed according to the input sequence.

The prior art requires another switch for changing the menu, whereas in the present invention, the menu can be changed by a motion input and thus the number of switches can be reduced, further reducing the size of the equipment.

What is claimed is:

1. A portable information device comprising:
a display;
at least one switch to be pressed;
at least one operation knob for pressing the switch;
at least one contact detector detecting contact with the operation knob;
first operation means for performing a first predetermined operation when the contact detector detects the contact with the operation knob;
time measurement means for measuring a time length of the contact with the operation knob;
comparing means for detecting whether the measured time length is longer or shorter than a predetermined value; and
second operation means for performing a second predetermined operation in response to the detection result of the comparing means.

2. The device according to claim 1, which further comprises contact determination means, wherein
there are provided a plurality of the contact detectors, each of which is assigned to a predetermined direction,
the contact determination means detects a selected contact detector that is selected by contact therewith,
the first operation means moves a cursor displayed on a display field of the display, in the predetermined direction assigned to the selected contact detector, and
the second operation means increases a speed of the cursor moved by the first operation means, when the comparing means detects that the measured time length is longer than the predetermined value.

3. The device according to claim 2, which further comprises scroll means, wherein
the display has a scrolling area on an edge portion around the display field,
the scroll means scrolls, when the first operation means moves the cursor to enters the scrolling area in an entering direction and continues its operation, a screen image displayed in the display field in an direction that is opposite to the entering direction.

4. The device according to claim 2, which further comprises press determination means and scroll means, wherein
there are provided a plurality of the switches, each of which is assigned to a predetermined direction,
the press determination means detects a selected switch that is selected by pressing; and
the scroll means scrolls a screen image displayed in the display field in an direction that is opposite to the predetermined direction assigned to the selected switch.

5. The device according to claim 2, which further comprises press determination means wherein
there are provided a plurality of the switches, each of which is assigned to a predetermined direction,
the press determination means detects a selected switch that is selected by pressing; and
the first operation means increases, when the press determination means detects the selected switch, a moving speed of the cursor in the predetermined direction assigned to the selected switch.

6. The device according to claim 2, which further comprises press determination means, select means, and select and shift means, wherein
there are provided a plurality of the switches, each of which is assigned to a predetermined direction,
the press determination means detects a selected switch that is selected by pressing;
the select means activates, when the press determination means detects the selected switch, an icon around the cursor; and
the select and shift means activates, when the select means activates the icon, another icon disposed in the predetermined direction assigned to the selected switch relative to the active icon as a replacement for the active icon.

7. The device according to claim 2, which further comprises consecutive contact detection means, wherein
a predetermined number of contact detectors of the plurality of the contact detectors are sequentially arranged,
the consecutive contact detection means detects whether or not a consecutive contact with the operation knob is detected by the predetermined number of sequentially arranged contact detectors and also detects a detection sequence of the sequentially arranged contact detectors used,
the time measurement means measures, when the consecutive contact detection means detects the consecutive contact, a time length of the detected consecutive contact with the operation knob, and
the second operation means zooms in or out on a display screen according to the detection sequence thus detected by the consecutive contact detection means when the comparing means determines that the measured time length of the consecutive contact is shorter than the predetermined value.

8. The device according to any one of claims 2, 3 and 7, wherein
each of the switch makes click,
there are provided at least four switches being disposed in four directions relative to a center of the operation knob and selected by pressing by the operation knob,
at least four of the contact detectors are disposed on four positions at regular angular intervals around the center of the operation knob so that each of the contact detectors corresponds to each of the switches, and
the predetermined direction assigned to each of the contact detectors corresponds to a direction along which the contact detector are disposed relative to the center of the operation knob.

9. The device according to any one of claims 4, 5 and 6, wherein
each of the switches makes click,
at least four of the plurality of the switches are disposed in four directions relative to a center of the operation knob and selected by pressing by the operation knob,
at least four of the contact detectors are disposed on four positions at regular angular intervals around the center of the operation knob so that each of the contact detectors corresponds to each of the switches,
the predetermined direction assigned to each of the contact detectors corresponds to a direction along which the contact detector is disposed relative to the center of the operation knob, and
the predetermined direction assigned to each of the switches corresponds to a direction along which the switch is disposed relative to the center of the operation knob.

10. The device according to claim 1, which further comprises a consecutive contact detector, wherein
there are provided a plurality of the switches, each of which is allocated to perform each of predetermined functions of a first set, respectively,
there are provided a plurality of the operation knobs so that each of the operation knobs corresponds to each of the switches, respectively,
there are provided a plurality of the contact detectors so that each of the contact detectors corresponds to each of the operation knobs, respectively,
the contact detectors are sequentially arranged,
the consecutive contact detection means detects whether a consecutive contact with a predetermined number of the operation knobs is detected by a predetermined number of the sequentially arranged contact detectors,
the time measurement means measures, when the consecutive contact detection means detects the consecutive contact, a time length of the detected consecutive contact with the operation knobs, and
the second operation means changes the predetermined functions of the first set to predetermined functions of a second set that are allocated to the switches, when the comparing means determines the measured time length is shorter than the predetermined value.
